(19) United States
(12) Patent Application Publication
(10) Pub. No.: US 2009/0032454 A1
(43) Pub. Date: Feb. 5, 2009

(54) Filtering Package for Infusion Products

(76) Inventor: Gino Rapparini, Bologna (IT)

Correspondence Address: PAUL A. FATTIBENE;FATTIBENE & FATTIBENE, 2480 POST ROAD, SOUTHPORT, CT, 06890, US

(21) Appl. No.: 11/922,539

(22) PCT Filed: Jan. 8, 2007
(86) PCT No.: PCT/IB2007/000048

§ 371 Date: Feb. 26, 2008

(30) Foreign Application Priority Data
Jan. 26, 2006 (IT) BO2002A000041

(51) Int. Cl. B01D 29/50

(52) U.S. Cl. 210/337

(57) ABSTRACT

Filtering package for infusion products including a thin cylindrical structure (1) at whose ends are firmly attached filtering diaphragms (2;2′) that make the resulting body of package (3), containing the infusion product, underformable.

### FIELD OF THE ART

The present invention refers to packaging techniques and in particular concerns a filtering container to obtain infuses. International classification of reference B65b.

### STATE OF THE ART

Several types of capsules to obtain infuses such as ground coffee or other similar substances are known. In particular, two types of capsules are known whose bearing structure can be obtained by thermo-formation or by injection.

The known capsules, obtained by injection, are provided with a filtering diaphragm. However, they are very costly because the undeformability of their structure requires specific depths. Therefore, a considerable amount of material is needed for their making. The thermoformed capsules don't have the filtering diaphragm. Thus, when utilized they need the intervention of complex punching devices that are also very costly and difficult to wash.

The problem to be solved is thus to realize, by injection, very light filtering capsules with a thin walls. Also, it is important that such walls, after the closing with filtering membranes, would present an undeformable stretched flexible structure that would allows its easy handling during its practical use to obtain infuses, while at the same time would avoid the punching operation that is instead needed in the thermoformed capsules.

The solutions proposed by the present invention solves all the problems above mentioned, that still exist in the field of capsules for infuses, and allows for inexpensive manufacturing, practical handling, and simplicity of use also in machines such as standard espresso machines.

### DESCRIPTION

The invention is now disclosed by the following detailed description, with reference to the figures of the drawings that are included as an unrestrictive example.

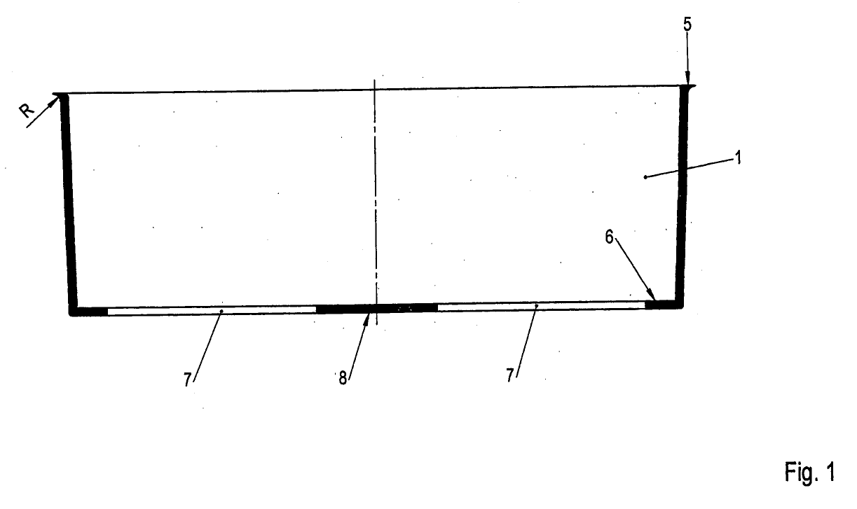

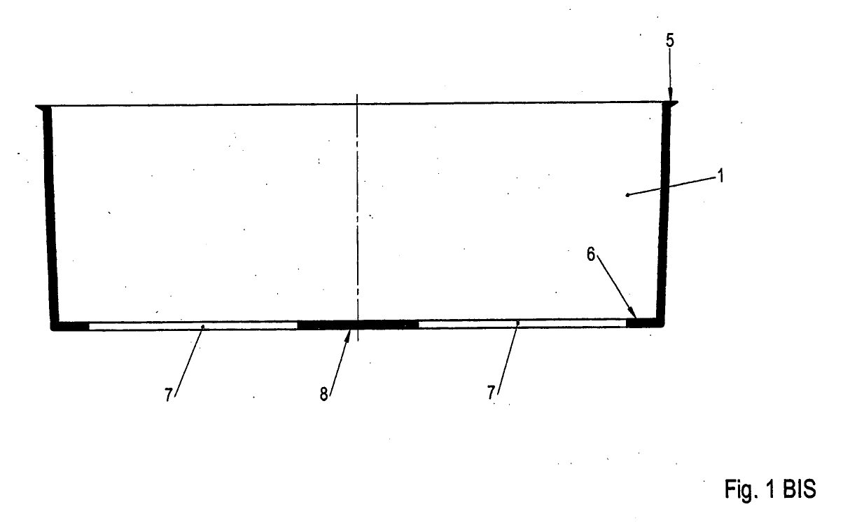

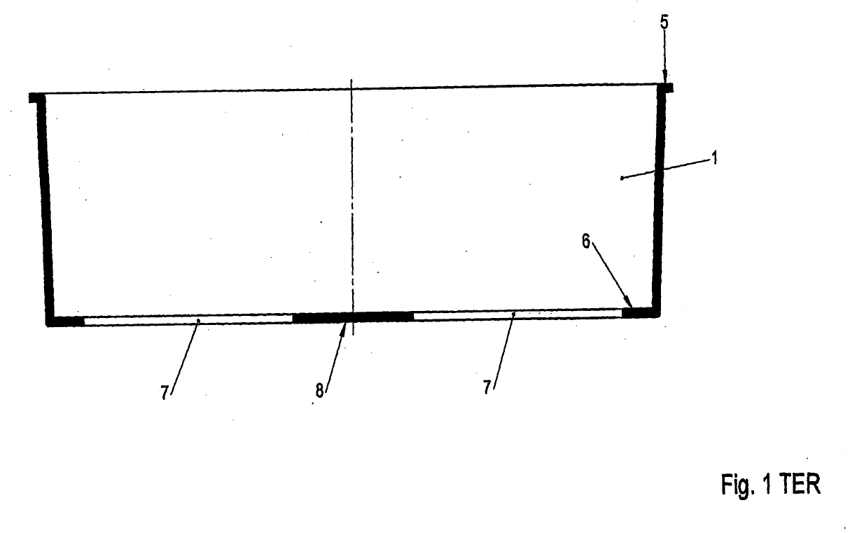

FIG. 1 shows schematically the axial section of the structure, which is basically cylindrical, of the container obtained by injection of the thermoplastic material. It can be noticed that the depth of the container is very thin, thus requiring a very small amount of thermoplastic material. Such small depth implies a structural deformability of the body of the container that is not tolerable. This occurs particularly around the upper area, surrounded by a flat flange (5) specifically linked with the lower part as indicated by the radius R. Around the lower part one can observe the presence of the edge (6) connected through the radial spokes (7) linking to the central zone (8). It is evident that such connection minimized the deformability of the container around the bottom part.

FIG. 1 bis indicates a geometric variation of the edge of the external flange (5) without the link (R).

FIG. 1 ter indicates another geometric variation of the end of flange (5).

FIG. 2 represents plant view of the container 1. On the upper end one can notice the presence of the external flat flange (5), while on the bottom there is a internal flat flange (6) with the spokes (7) linking to the central zone (8).

FIG. 2 bis shows a plant view of a different realization option of the container's body (1′). One can notice the external upper flange (5′) and the presence of the internal flange (6′) on the bottom. In the FIG. 2 one can observe the absence of the spokes and of their central linking zone.

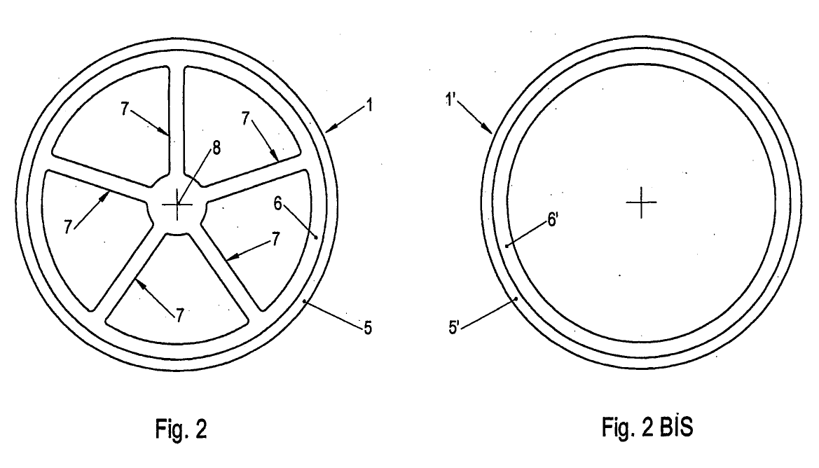

FIG. 3 highlights the deformability of the container (1), particularly around the upper end provided with flat flange (5). The figure highlights the fact that the simple fingers' pressure deforms the container giving it an elliptical shape. Instead, around the bottom, the presence of the flat flange (6) connected through the spokes (7) to the central zone (8) reduces the undeformability of the circular form of the bottom of said container (1).

Analyzing said FIG. 3 one can see that the body of the empty container is deformed by simple external pressure. It can be noticed that the cylindrical body takes an elliptic shape. Such deformability is instead avoided with the use and the peripheral application of filtering diaphragms to the two ends of the cylindrical body of the container.

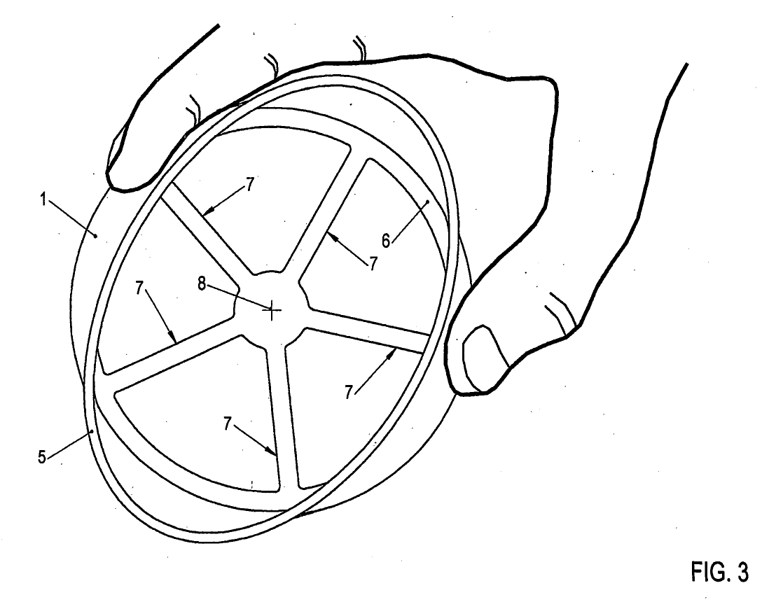

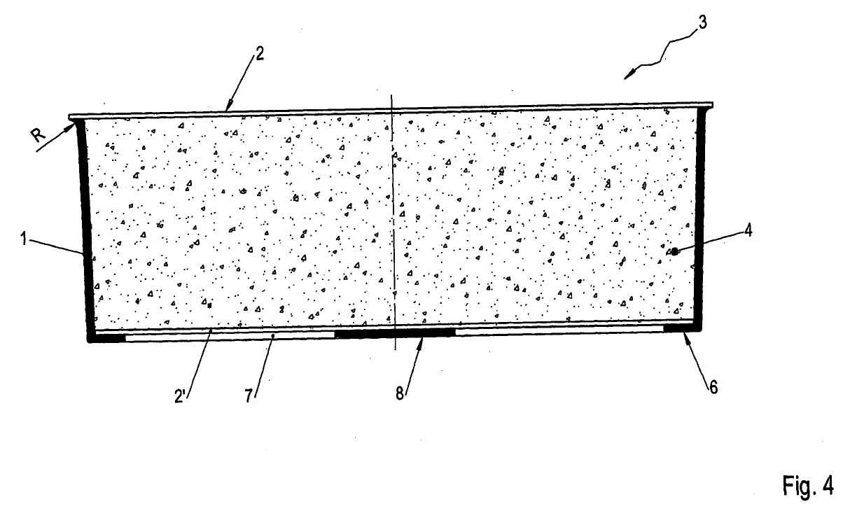

FIG. 4 shows in section a container packaged with infusion substances and with the two ends closed by filtering diaphragms (2; 2′) fixed peripherally to the upper external flange (5) ad to the lower internal flange (6) of the cylindrical body (1). It should be pointed out that the cylindrical body of the package works as stretched flexible structure that is undeformable from the outside, and this allows for an easy handling of the end product, that results geometrically stable. It should be noticed that the filtering diaphragm is realized with a material that is not stretchable, and that the circular shape of the package can't be altered when said diaphragm is attached along the edge of the two ends of the cylindrical body of the resulting package. It is exactly the fact that the filtering diaphragm isn't stretchable that allows the undeformability of the package after the packaging and the closing.

The resulting package has thus the same features of a rigid capsule with large thickness, but it is instead much less expensive since it is four times lighter in weight. This peculiar feature has been confirmed by intense and continuous testing performed on containers four times lower in weight than the already known capsules.

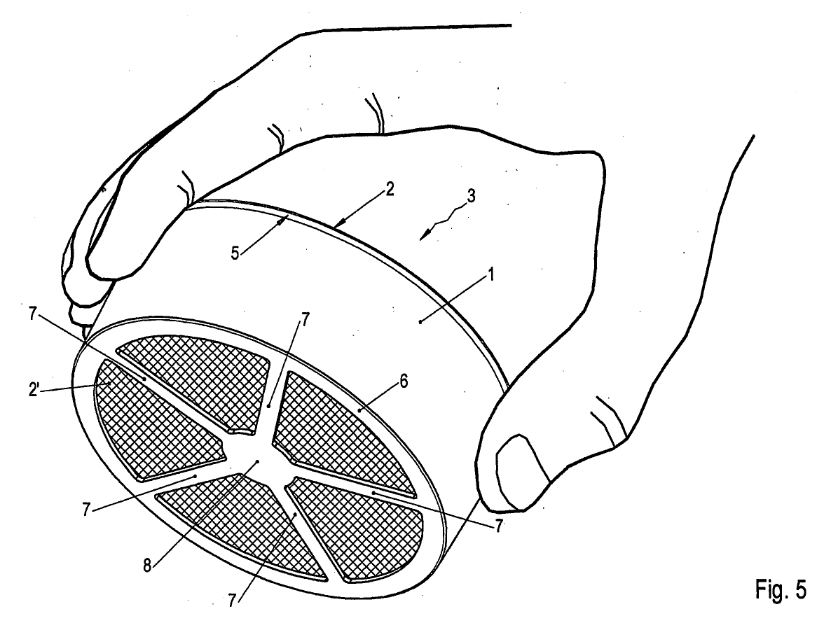

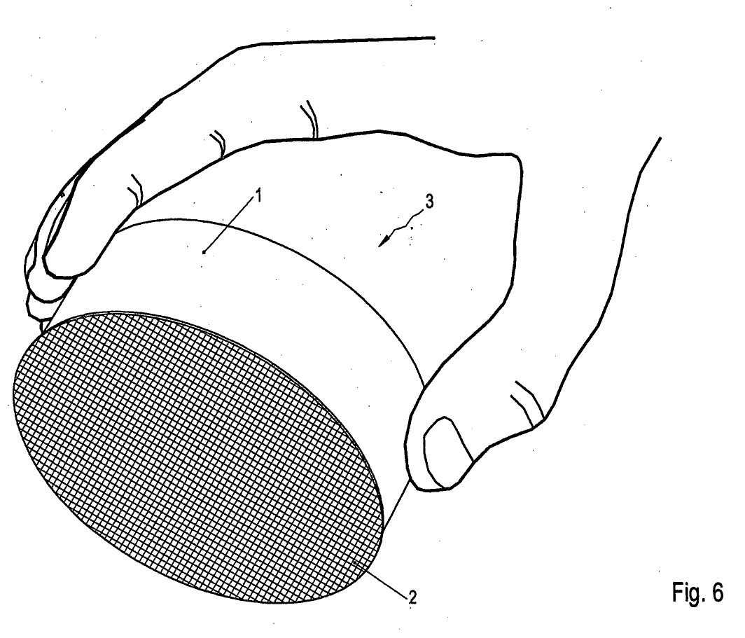

FIGS. 5 and 6 demonstrate the undeformability of the resulting package.

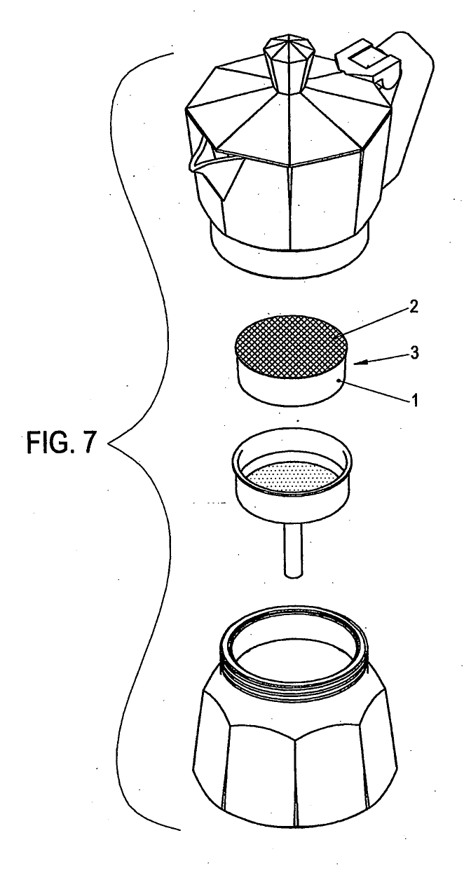

FIG. 7 shows the simplicity of use of a package (3) in a standard mocha or espresso machine.

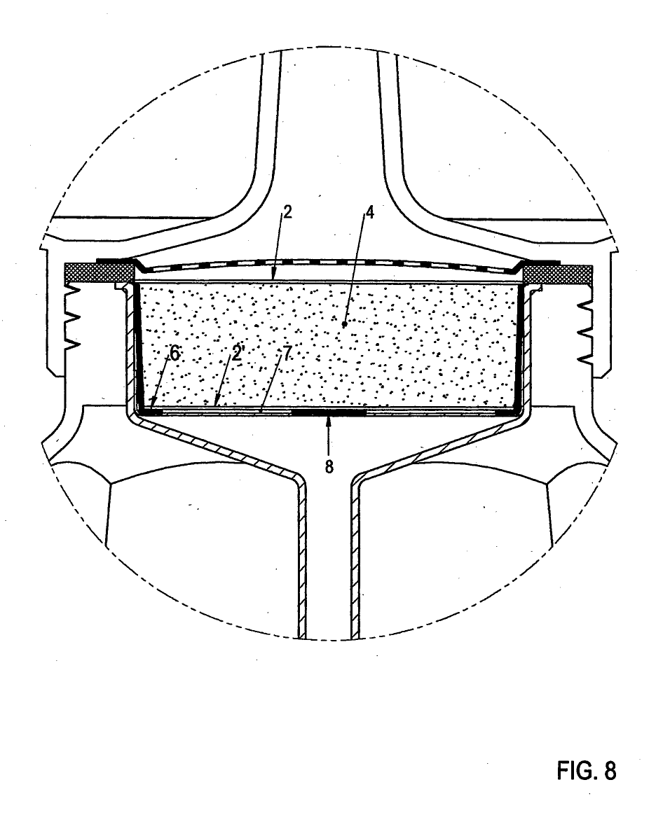

FIG. 8 shows the easyiness of use of a package (3) inserted in a machine for infuses such as standard mocha.

In the figures each single detail is marked as follows:
1 is a cylindrical container realized by injection with walls having very thin depth and requiring very small amounts of plastic material.
1′ is variation of the container.
2 is a filtering diaphragm attached onto the external flange (5) by the upper end of the cylindrical body (1).
2′ is a filtering diaphragm applied onto the internal flange (6).
3 is the end product.
4 is the packaged substance for the infusion.
5 is the upper external flange.
5′ is the upper external flange of a container 1′ that represents a variation.
6 indicates the internal flange at the bottom of the container 1.
6′ indicates the internal flange at the bottom of the container 1′.
7 indicates the stiffening spokes connecting to the flange 6 of the container 1.
8 indicates the central zone of linking said spokes 7.
R indicates the linked profile of the upper external flange (5) to optimize the use of the package in machines such as standard espresso machines.

The invention of course allows for several variations of practical realization as far as the dimensioning and the structural proportioning are concerned, as well as the morphologic and technologic choices of the production processes use for their industrial production.

Any technician skilled in this technological field will therefore be able, upon disclosing of the original inventive features of the present invention, of realizing without any invention effort, but simply by means of simple deductions, inexpensive filtering packages for infusions products having very thin walls and thus needing very small amount of plastic materials, but featuring exceptional handling for the geometric stability and undeformability.

All the filtering packages for infusion products that will have the same original characteristics as the present invention, as basically described, shown and hereinafter claimed, will be considered as being part of the protection sphere of the present invention.

1. Filtering package for infusion products including a thin cylindrical structure at whose ends are firmly attached filtering diaphragms that make the resulting body of package, containing the infusion product, undeformable.

2. Filtering package for infusion products, as in claim 1, wherein the thin cylindrical structure is realized by means of injection of thermoplastic materials.

3. Filtering package for infusion products, as in claim 1, wherein the thin cylindrical structure is realized starting from flat films of thermo-formable materials.

4. Filtering package for infusion products, as in claim 1, wherein the lower end of the thin cylindrical structure is provided with spokes connecting with the central zone.

5. Filtering package for infusion products, as in claim 1, wherein the resulting package is realized with structural and dimensional proportioning that make it particularly fit for the use in machines such as standard espresso machines.

6. A filtering package for infusion products comprising:
a deformable container having an upper flange and a bottom flange, wherein said deformable container is flexible; and
an upper rigid undeformable filtering diaphragm attached to the upper flange of said deformable container; and
a bottom rigid undeformable filtering diaphragm attached to the bottom flange of said deformable container,
whereby the filtering package is substantially undeformable.

7. A filtering package for infusion products as in claim 6 further comprising:
a packaged substance placed between said upper rigid undeformable filtering diaphragm and said bottom rigid undeformable filtering diaphragm,
whereby said package substance may be infused.

8. A filtering package for infusion products as in claim 7 wherein:
said packaged substance comprises coffee.

9. A filtering package for infusion products as in claim 6 wherein:
said deformable container is cylindrical.

10. A filtering package for infusion products as in claim 6 wherein:
said deformable container comprises a thermoplastic material.

11. A filtering package for infusion products as in claim 6 wherein:
a distal end of said upper flange extends radially away from the interior of said deformable container and a distal end of said bottom flange extends radially towards the interior of said deformable container.
